(19) United States
(12) Patent Application Publication
(10) Pub. No.: US 2010/0000018 A1
(43) Pub. Date: Jan. 7, 2010

(54) Side Guard for Bed

(76) Inventors: Mario Cesar Eleonori, Martinez (AR); Eduardo Rene Benzo, Celina (AR)

Correspondence Address: ERIC W. CERNYAR, P.C., 1122 GOLDEN CYCLE CIRCLE, CRIPPLE CREEK, CO, 80813, US

(21) Appl. No.: 12/176,338

(22) Filed: Jul. 19, 2008

Related U.S. Application Data
(60) Provisional application No. 61/078,355, filed on Jul. 4, 2008.

(51) Int. Cl. A61G 7/05; A47C 21/08; A61G 7/015

(52) U.S. Cl. 5/613; 5/428; 5/427

(57) ABSTRACT

A bed includes a side guard that provides a continuous protected surface from the headboard to the footboard of a bed. The side guard includes a top guard bar mounted within vertical guides. The guides prevent horizontal or rotational movement of the top guard but permits movement of the top guard between an elevated and lowered position. A scrollable protection barrier extends from the top guard bar to a torsion spring roller at the base of the side guard, preventing a patient from becoming entrapped between the bars. A balanced-movement lift mechanism evenly distributes the forces raising or lowering the superior guard bar of the side guard.

### RELATED DISCLOSURES

This application claims priority to and incorporates herein by reference our provisional patent application Ser. No. 61/078,355 entitled “Side Guard for Bed” filed on Jul. 4, 2008. This invention also relates to, and this application incorporates herein by reference, the disclosure by Eduardo R. Benzo, Rodolfo W. Ferraresi, and Mario C. Eleonori entitled Hospital Bedrails Attachment (Dynarail) received by the Patent and Trademark Office on or about Jul. 19, 2006, as part of the Patent and Trademark Office's Document Disclosure Program and given Document Disclosure number 603705.

### FIELD OF THE INVENTION

This invention relates generally to side guards for beds, and more particularly, to side guards for hospital, nursing home, and home healthcare beds.

### BACKGROUND OF THE INVENTION

Hospital beds frequently include side guards, often referred to as side rails, guard rails or bed rails, to prevent a patient from rolling off the bed. The FDA classifies side guards into different rail types. A full-length rail is a one-piece rail that extends along the side of the bed from the head end to the foot end of the bed. A ¾-length rail is a one-piece rail that extends along the side of the bed three-quarters of the way down from the head end of the bed. A half-length rail is a one-piece rail that extends along the side of the bed one-half the length of the bed from the head end of the bed. A quarter-length rail is a one-piece rail that extends along the side of the bed approximately ¼ the length of the bed from the head of the bed. Split rails comprise a pair of half rails. One set extends along the side of the bed from the head end of the bed to the mid-section of the bed. The other set extends from the mid-section of the bed to the foot end of the bed. Generally, there is a space between the two sets of rails.

Of the side guards applicants are aware of in hospital use, all have areas of possible entrapment and none have a constant continual protection. Many side guards have scissors-like members in which patients or their tubing may become entrapped. Many side guards also pivot below the patient support surface, and when pivoted, can entrap a patient or a patient's tubing.

There is a need for improved side guard designs designed to prevent entrapment of patients and their tubing.

### SUMMARY OF THE INVENTION

A movable side guard is described that provides a continuous protected surface from the headboard to the footboard of a bed. The side guard moves between an elevated position and a lowered position below the support surface of the bed. The side guard comprises a plurality of bars that spread apart as the side guard moves into the elevated position, and that collapse upon each other as the side guard moves into a fully lowered position. The movement of the bars is constrained in the vertical direction. The bars are mounted within vertical guides that prevent horizontal translational or rotational movement. Moreover, a scrollable protection barrier extends from the top side guard bar to a torsion spring roller at the base of the side guard.

Because the side guard extends from the headboard to the footboard of the bed, it eliminates gaps found in many prior art guard rails in which patients or patient tubing can become entrapped. Also, the inclusion of a scrollable barrier that is kept in tension by the roller prevents a patient from becoming entrapped between the bars.

Several different embodiments of balanced-movement lift mechanisms are presented to evenly distribute the forces raising or lowering the superior guard bar of the side guard. One embodiment comprises a closed drive loop, suspended on a plurality of pulleys, that is coupled at two fixed points on the closed drive loop to opposite ends of the superior guard bar. Movement of the closed drive loop balances the forces on and synchronously raises or lowers both opposite ends of the superior guard bar. Another embodiment comprises two tensioned lines, each extending between opposite corners of the side guard support structure, and each also suspended on pulleys mounted on opposite ends of the superior guard bar. This balanced-motion mechanism redistributes some of the force that is directed at one end of the superior guard, to raise or lower it, to the opposite end of the side guard. Yet another embodiment comprises a scissors-like mechanism that maintains proportional spacing between each of the guard bars and an actuator that operates on two of the scissors-like members. The scrollable barrier protects patients from entrapment in the scissors-like members.

In some embodiments, a powered lift actuator is provided to move the closed drive loop or one of the ends of the superior guard bar. In other embodiments, the superior guard bar is raised or lowered by hand, and a compression spring is provided to bias the superior guard bar toward a raised position.

It is the inventors' intent that the scope of any of the claims be defined by the language of the claims, and not narrowed by reference to the preferred embodiments described in this summary or in the detailed description of the invention.

### BRIEF DESCRIPTION OF THE DRAWINGS

FIG. 1 illustrates one embodiment of a side guard apparatus for a bed, with a plurality of guard bars in a fully elevated position.

FIG. 2 is a perspective view of the foot end of the side guard apparatus of FIG. 1, revealing in closer detail many of the components of a lift mechanism for the guard bars.

FIG. 3 illustrates the side guard apparatus of FIG. 1, with the guard bars in a mostly but not fully elevated position.

FIG. 4 is a perspective view of the side guard apparatus of FIG. 3, revealing the altered position of some of the components of the lift mechanism to support the guard bars in their mostly but not fully elevated position.

FIG. 5 illustrates the side guard apparatus of FIG. 1, with the guard bars in a half-way elevated position.

FIG. 6 is a perspective view of the side guard apparatus of FIG. 5, revealing the altered position of some of the components of the lift mechanism to support the guard bars in their half-way elevated position.

FIG. 7 illustrates the side guard apparatus of FIG. 1, with the guard bars in a mostly but not fully lowered position.

FIG. 8 is a perspective view of the side guard apparatus of FIG. 7, revealing the altered position of some of the components of the lift mechanism to support the guard bars in their mostly but not fully lowered position.

FIG. 9 illustrates the side guard apparatus of FIG. 1, with the guard bars in a completely lowered position.

FIG. 10 is a perspective view of the side guard apparatus of FIG. 9, revealing the altered position of some of the components of the lift mechanism to position the guard bars in their completely lowered position.

FIG. 11 is an exploded view diagram of the components of one embodiment of a torsion spring roller assembly.

FIG. 12 illustrates an alternative embodiment of a side guard apparatus for a bed, with a plurality of guard bars in a fully elevated position.

FIG. 13 illustrates the side guard apparatus of FIG. 12 with the plurality of bars in a half-way elevated position.

FIG. 14 illustrates the side guard apparatus of FIG. 12 with the plurality of bars in a fully lowered position.

FIG. 15 is a perspective view of a terminal end of the superior guard bar of the side guard apparatus of FIG. 12, revealing its connection with a linear actuator mechanism as well as two pulleys and cables used to balance the forces on either side of the superior guard bar.

FIG. 16 illustrates another alternative embodiment of a side guard apparatus for a bed, with a hand-operated, manual lift mechanism for raising and lowering the guard bars.

FIG. 17 illustrates a hand-operated brake mechanism for the side guard apparatus of FIG. 16.

FIG. 18 illustrates the side guard apparatus of FIG. 16 with the plurality of bars in a half-way elevated position.

FIG. 19 illustrates the side guard apparatus of FIG. 16 with the plurality of bars in a completely lowered position.

FIG. 20 illustrates one embodiment of the terminal end of a superior guard rod.

FIG. 21 illustrates an articulating hospital bed with one of the side guard apparatuses of the present invention.

FIG. 22 illustrates another embodiment of a side guard apparatus for a bed, with a plurality of guard bars, in a fully elevated position, that maintain proportional spacing at any elevation.

FIG. 23 illustrates the side guard apparatus of FIG. 22 in a partially elevated position.

FIG. 24 illustrates the side guard apparatus of FIG. 22 in a fully lowered position.

FIG. 25 is a perspective view of the foot end of the side guard apparatus of FIG. 22, revealing in closer detail many of the components of a lift mechanism for the guard bars.

FIG. 26 is a perspective view of the foot end of the side guard apparatus of FIG. 23, revealing in closer detail many of the components of a lift mechanism for the guard bars.

FIG. 27 is a perspective view of the foot end of the side guard apparatus of FIG. 24, revealing in closer detail many of the components of a lift mechanism for the guard bars.

FIG. 28 illustrates another embodiment of a side guard apparatus for a bed, with a different lift mechanism and a plurality of guard bars that maintain proportional spacing at any elevation.

FIG. 29 is a perspective view of the side guard apparatus of FIG. 28.

### DETAILED DESCRIPTION

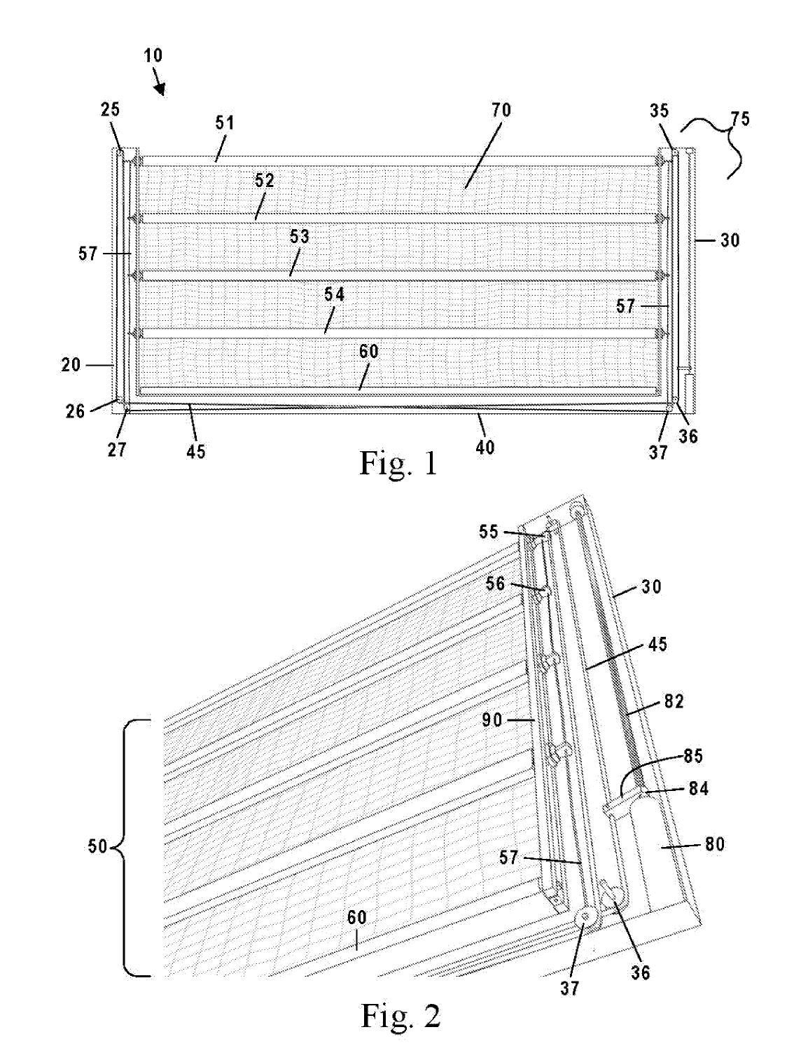

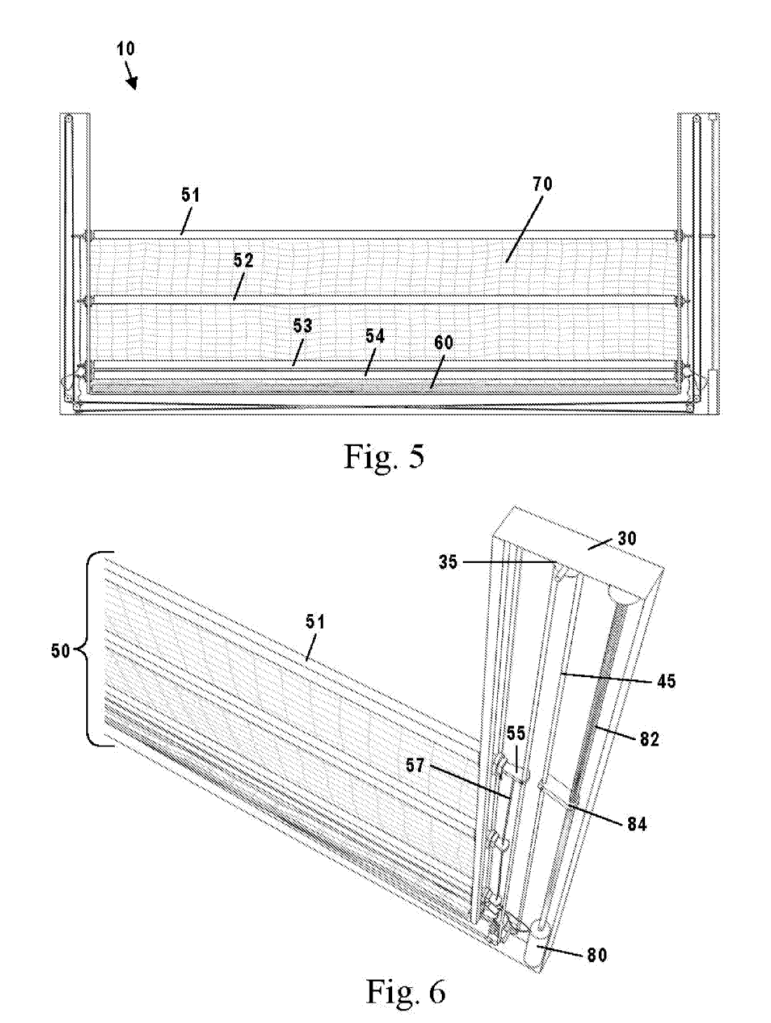

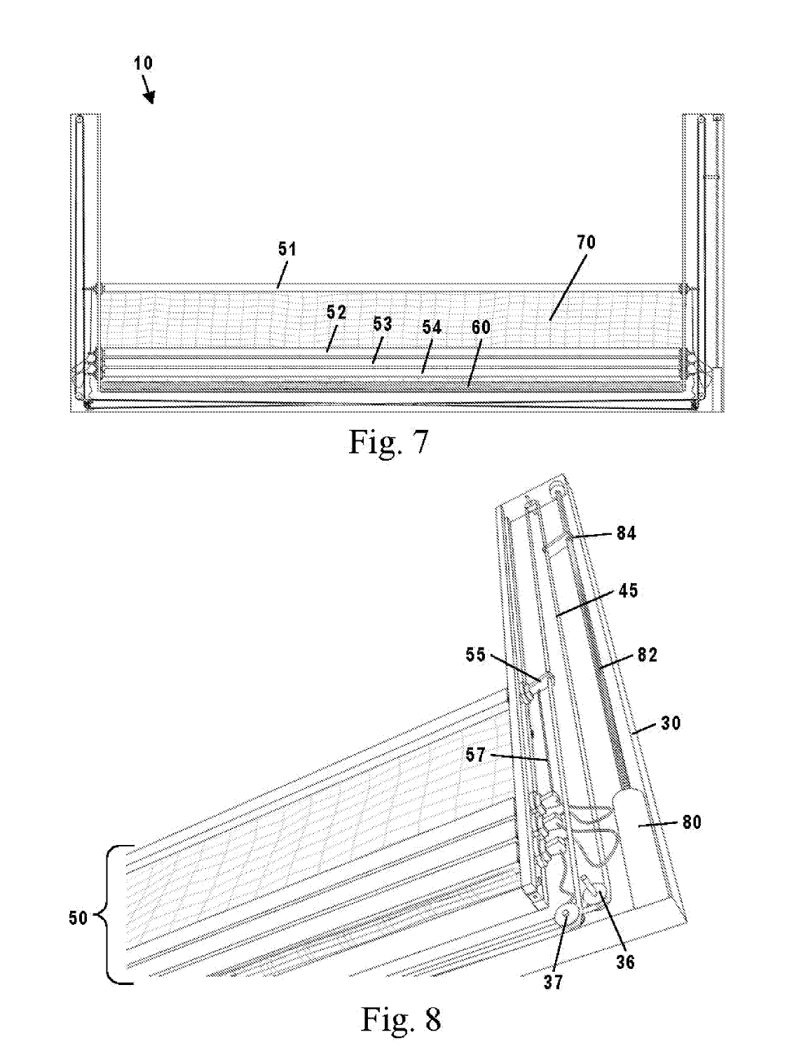

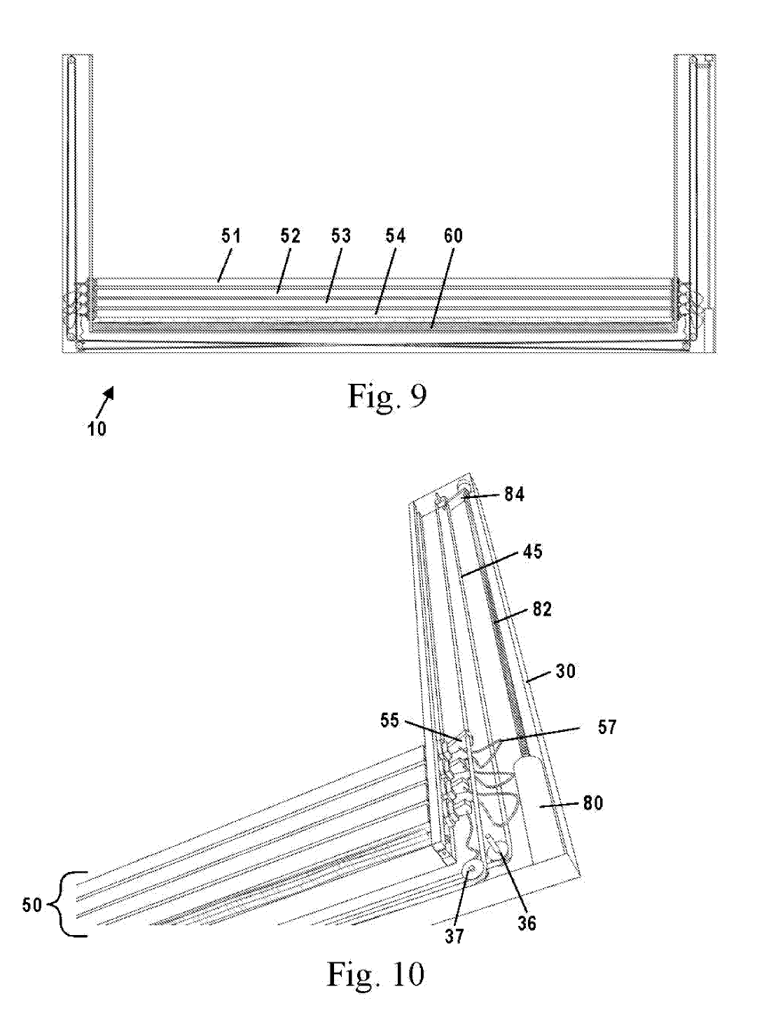

In describing preferred and alternate embodiments of the technology described herein, as illustrated in FIGS. 1-29, specific terminology is employed for the sake of clarity. The technology described herein, however, is not intended to be limited to the specific terminology so selected, and it is to be understood that each specific element includes all technical equivalents that operate in a similar manner to accomplish similar functions.

FIGS. 1-10 illustrate one embodiment of a side guard apparatus 10. Side guard apparatus 10 comprises a side guard 50, a pulley-based balanced motion lift mechanism 75 for raising and lowering the side guard 50 between elevated and lowered positions, and a foot-end guide mechanism or post 30, a head-end guide mechanism or post 20, and a base bar 40 that houses the lift mechanism 75 and provides structural rigidity to the side guard apparatus 10. The side guard apparatus 10 may be installed on a pre-existing bed (not shown), or alternatively the side guard 50 and lift mechanism 75 may be installed within the existing structure of a bed, as shown in FIG. 21.

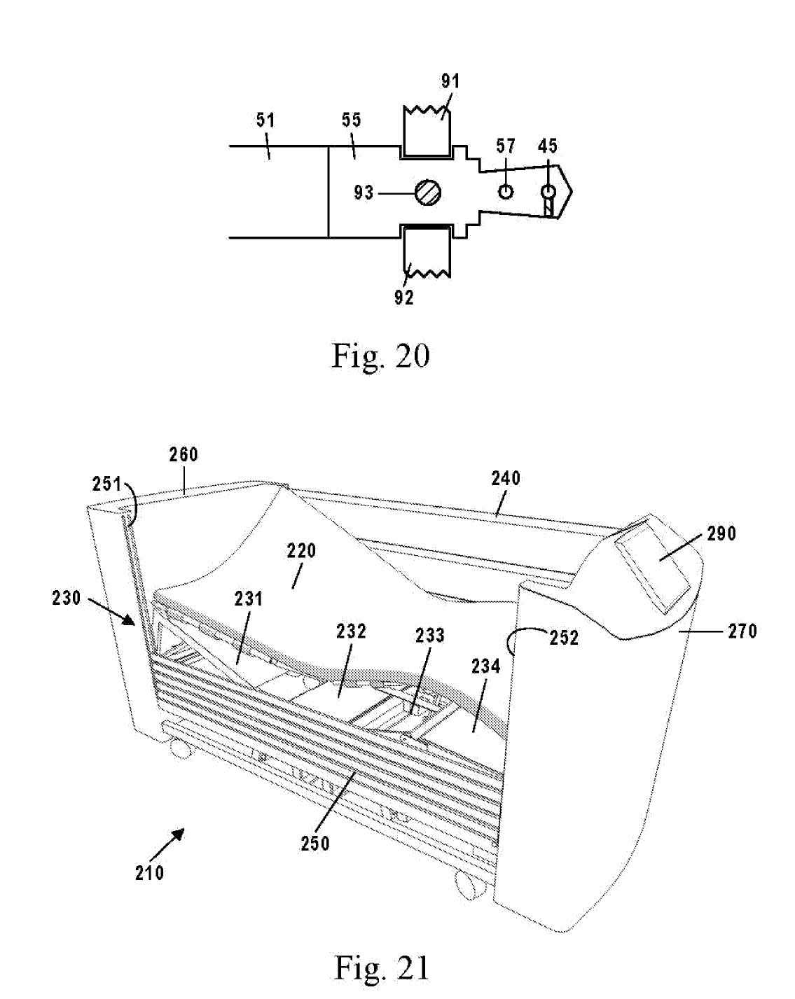

The side guard 50 comprises a superior guard bar 51 that supports (and, in some embodiments, defines) a top horizontal edge of the side guard 50, a plurality of movable guard bars 52-54 suspended below the superior guard bar 51 by flexible elongated connectors 57 (e.g., lift cords, lift ropes, or lift straps), a substantially continuous flexible barrier 70 positioned on a support-surface-facing-side of a bed (not shown), and a roller 60 that rolls up (or unwinds) the flexible barrier 70 as the guard bars 51-54 descend (or ascend). The guard bars 51-54 are free to move only within a vertical plane, and only up and down. The terminal ends of guard bars 51-54 are slidably mounted between the rails 91, 92 (FIG. 20) of vertical guides or tracks 90 positioned on or near the inside surfaces of the guide posts 20 and 30, thereby restraining the movement of the guard bars 51-54 within that vertical plane. Furthermore, stems 55 and 56 on the terminal ends of guide bars 51-54 are slidably mounted on guide rods 93 (FIG. 17) that are housed within guide posts 20 and 30.

The lift mechanism 75 is operable to raise and lower the guard bars 51-54 within that vertical plane between lowered and elevated positions without rotating the guard bars 51-54. The lift mechanism 75 comprises a closed drive loop 45 (e.g., a steel cable, a cord, a chain, a belt, etc.) mounted on a plurality of pivots 25-27 and 35-37, and a linear actuator 80. The pivots 25-27 and 35-37 comprise pulleys, gears, bearings, fulcrums or other structures that enable movement of one portion of the loop 45 in one vector direction to cause movement of another portion of the loop 45 in a different vector direction. Terminal couplings 55 on opposite head and foot ends of the superior guard bar 51 fixedly couple the superior guard bar 51 to points on the closed drive loop 45. Movement of the closed drive loop 45 synchronously raises, or lowers, both ends of the superior guard bar 51.

To illustrate how the closed drive loop 45 is able to do this, it is helpful to conceptualize six ordered points along the loop 45 and follow from one point to the next as the loop begins to move in one or the other direction. A first point of the closed drive loop 45 pivots around a pulley 35 mounted near the top of the foot-end guide post 30, while a second point of the loop 45 pivots around a pulley 36 mounted near the bottom of the foot-end guide post 30, while a third point of the loop 45 pivots around a pulley 27 mounted near the bottom of the head-end guide post 20, while a fourth point of the loop 45 pivots around a pulley 25 mounted near the top of the head-end guide post 20, while a fifth point of the loop 45 pivots around a pulley 26 mounted near the bottom of the head-end guide post 20, while a sixth point of the loop 45 pivots around a pulley 37 mounted near the bottom of foot-end guide post 30. In this manner, the closed drive loop 45 is operable to raise or lower both ends of the superior guard bar 51 at the same time.

The linear actuator 80 moves the closed drive loop 45 between the limits of its range of travel, which is between positions in which the superior guard bar 51 is in its fully elevated and fully lowered positions, respectively. The linear actuator 80 depicted in FIGS. 1-10 is a screw-type linear actuator that rotates an eternally-helically-threaded shaft 82. An internally-helically-threaded leadscrew nut 84 is mounted on the shaft 82. Rotation of the shaft 82 in one direction raises the nut 84, and rotation of the shaft 82 in the opposite direction lowers the nut 84. A stem 85 of the nut 84 is fixedly attached to the closed drive loop 45. Accordingly, actuation of the linear actuator 80 causes the nut, and by extension the closed drive loop 45, to move between the limits of its range of travel.

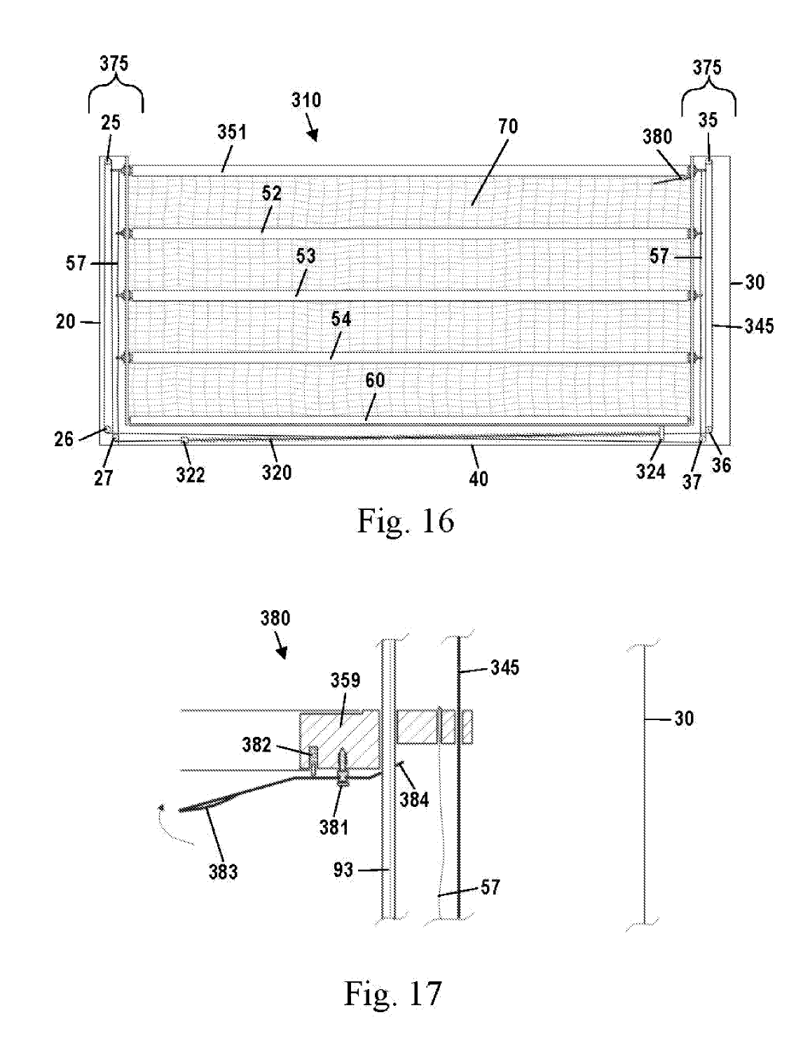

In other embodiments (for which illustration is not necessary but which may be encompassed within the claims), the screw-type linear actuator 80 of FIGS. 1-10 is substituted with other types of actuators, including, for example, a rod type linear actuator or even—if the closed drive loop 45 is a chain or includes a chain portion, and one of the pivots 35-37 is a gear or sprocket—a rotary actuator that drives the pivot. In yet other embodiments, instead of just one actuator, two actuators, one in each guide post 20 and 30, are used. In yet further embodiments, as illustrated later in connection with FIGS. 16-19, the lift mechanism 75 does not utilize a motorized or powered actuator at all.

As noted previously, the inferior guard bars 52-54 are suspended below the superior guard bar 51 by elongated flexible connectors (e.g. lift cords) 57. Terminal couplings 57 on opposite terminal ends of each of the inferior guard bars 52-54 fixedly couple the inferior guard bars 52-54 to the flexible connectors 57. Due to the laws of gravity, these flexible connectors 57 position the guard bars 51-54 in spaced-apart relation when the superior guard bar 51 is in its elevated position, and allow the bars 51-54 to collapse upon each other when the superior guard bar 51 is in its lowered position. FIGS. 1-10 illustrate the relative spaced-apart relations of the guard bars 51-54 as the side guard 50 descends from its most elevated position to its most lowered position.

The flexible, scrollable barrier 70 is suspended from the superior guard bar 51 and extends downwardly along an interior, support-surface-facing side of the side guard 50. Its purpose is to provide a mechanical barrier to prevent entrapment of the patient's body parts and/or therapeutic tubing. It is preferably made of a breathable, inelastic material so that a patient whose face is resting against the barrier can still breathe. The flexible barrier 70 may comprise a mesh fabric or fabric sheet, PVC, plastic sheeting material, flexible net, or other suitable materials. Although it may be opaque, it is preferably transparent and translucid to make it easier for hospital practitioners to monitor the patient. It is also preferably made of a relatively inexpensive disposable material, so that it can be discarded after any given patient's use.

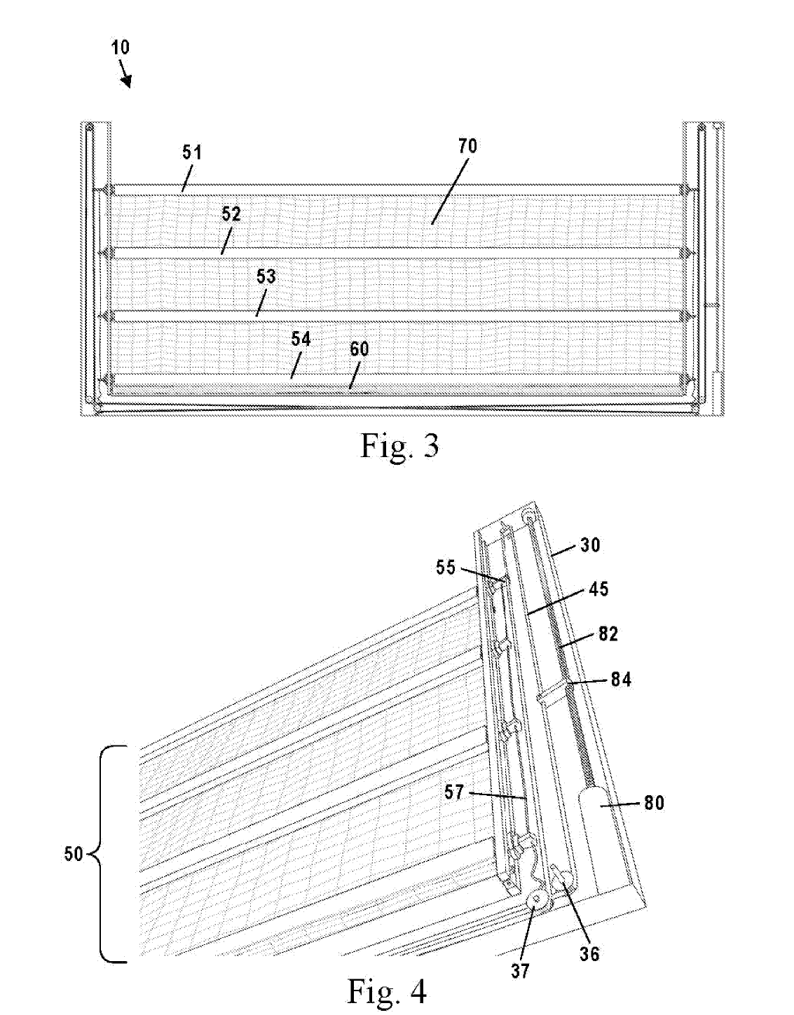

The roller 60, which is preferably mounted at the bottom of the side guard 50 but may alternatively be mounted on or inside a recess of the superior guard bar 51 itself, holds the flexible barrier 70 in tension and winds up the flexible barrier 70 about itself as the superior guard bar 51 descends into the lowered position. FIGS. 3-10 illustrate the winding up of the flexible barrier 70 about the roller 60 as the side guard 50 descends from its most elevated position to its most lowered position.

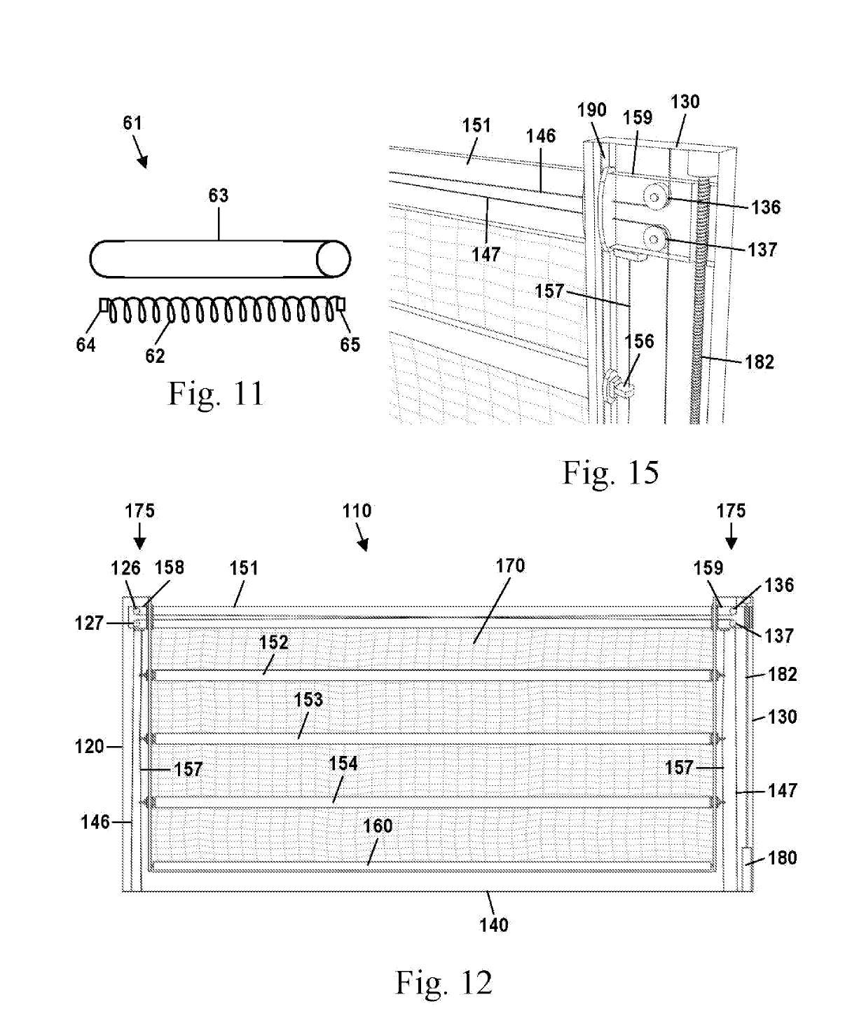

FIG. 11 illustrates the assembly 61 of components that make up the roller 60. The roller 60 comprises an internal torsion spring 62 mounted inside a scrollable rod 63. One end 64 of the torsion spring 62 is fastened to the inside of the rod 63, and turns with it. The other end 65 is fastened to one of the guide posts 20 and 30. Therefore, as the roller 60 turns, it either builds or releases tension in the torsion spring 62. When installed, the torsion spring 62 is set to be in maximum tension when the superior guard rod 51 is in its most elevated position, but still in tension when the superior guard rod 51 is in its lowest position, so that whatever position the superior guard rod 51 is in, the flexible barrier 70 is always held in tension. The degree of tension depends on the torsion spring 62. Preferably, the torsion spring 62 is configured to exert enough tension that, irrespective of the position of this side guard 50, the flexible barrier 70 will always be under enough tension to resist that any object (or patient's part) that may push outwards.

FIGS. 12-15 illustrate an alternative embodiment of a side guard apparatus 110. Side guard apparatus 110 comprises a side guard 150, a pulley-based balanced motion lift mechanism 175 for raising and lowering the side guard 150 between elevated and lowered positions, and a foot-end guide post 130 and head-end guide post 120 that houses most of the lift mechanism 175. A base bar 140 (or the bed frame itself) provides structural rigidity to the side guard apparatus 110. The side guard apparatus 110 may be installed on a pre-existing bed (not shown), or alternatively the side guard 150 and lift mechanism 175 may be installed within the existing structure of a bed, as shown in FIG. 21.

The side guard 150 comprises a superior guard bar 151 that supports (and, in some embodiments, defines) a top horizontal edge of the side guard 150, a plurality of movable guard bars 152-154 suspended below the superior guard bar 151 by flexible elongated connectors 157 (e.g., lift cords, lift ropes, or lift straps), a substantially continuous flexible barrier 170 positioned on a support-surface-facing-side of a bed (not shown), and a roller 160 that rolls up (or unwinds) the flexible barrier 170 as the guard bars 151-154 descend (or ascend). The guard bars 151-154 are free to move only within a vertical plane, and only up and down. The terminal ends of guard bars 151-154 are slidably mounted between the rails 91, 92 (FIG. 20) of vertical guides or tracks 190 positioned on or near the inside surfaces of the guide posts 120 and 130, thereby restraining the movement of the guard bars 151-154 within that vertical plane. Furthermore, the head and foot ends 158, 159 of the superior guard bar 151 and the terminal stems 156 of inferior guide bars 152-154 are slidably mounted on guide rods 93 (FIG. 17) that are housed within guide posts 120 and 130.

The lift mechanism 175 is operable to raise and lower the guard bars 151-154 within that vertical plane between lowered and elevated positions without rotating the guard bars 151-154. The lift mechanism 75 comprises a first pair of pivots 126, 127 mounted on the head end 158 of the superior guard bar 151, a second pair of pivots 136, 137 mounted on the foot end 157 of the superior guard bar 151, first and second tensioned lines 146 and 147 (e.g., steel cables, ropes, cords, chains, straps), and a linear actuator 180. The first tensioned line 146 starts at a lower portion of the head end guide post 120, extends over pivot 127, extends across the superior guard bar 151, extends under pivot 136, and terminates near a top end of the foot end guide post 130. The second tensioned line 147 starts at a lower portion of the foot end guide post 130, extends over pivot 137, extends across the superior guard bar 151, extends under pivot 126, and terminates near a top end of the head end guide post 120. The pivots 126, 127, 136, 137 comprise pulleys, gears, bearings, fulcrums or other structures that enable movement of one portion of one of the tensioned lines 146, 147 in one vector direction to cause movement of another portion of the tensioned line 146 or 147 in a different vector direction.

The foot end 159 of the superior guard bar 151 includes an internally threaded rotary shaft coupling that mates with the externally-helically-threaded shaft 182. The linear actuator 180 moves the superior guard bar 151 between the limits of its range of travel, that is, between in its fully elevated and fully lowered positions. The linear actuator 180 depicted in FIGS. 12-15 is a screw-type linear actuator that rotates an externally-helically-threaded shaft 182. Rotation of the shaft 182 in one direction raises the superior guard bar 151, and rotation of the shaft 182 in the opposite direction lowers the superior guard bar 151.

In other embodiments (not shown) the screw-type linear actuator 180 of FIGS. 12-15 is substituted with other types of actuators, including, for example, a rod type linear actuator. In yet other embodiments, instead of just one actuator, two actuators, one in each guide post 120 and 130, are used. In yet other embodiments, the lift mechanism 175 does not utilize a motorized or powered actuator at all but is rather manually-powered.

The system of pivots 126, 127, 136, 137 and tensioned lines 146, 147 causes the pulley-balanced lift mechanism 175 to raise or lower both ends 158, 159 of the superior guard bar 151 equally and synchronously. As noted previously, the inferior guard bars 152-154 are suspended below the superior guard bar 151 by elongated flexible connectors (e.g. lift cords) 157. Terminal couplings 156 on opposite terminal ends of each of the inferior guard bars 152-154 fixedly couple the inferior guard bars 152-154 to the flexible connectors 157. Due to the laws of gravity, these flexible connectors 157 position the guard bars 151-154 in spaced-apart relation when the superior guard bar 151 is in its elevated position, and allow the bars 151-154 to collapse upon each other when the superior guard bar 151 is in its lowered position. FIGS. 12-14 illustrate the relative spaced-apart relations of the guard bars 151-154 as the side guard 150 descends from its most elevated position to its most lowered position.

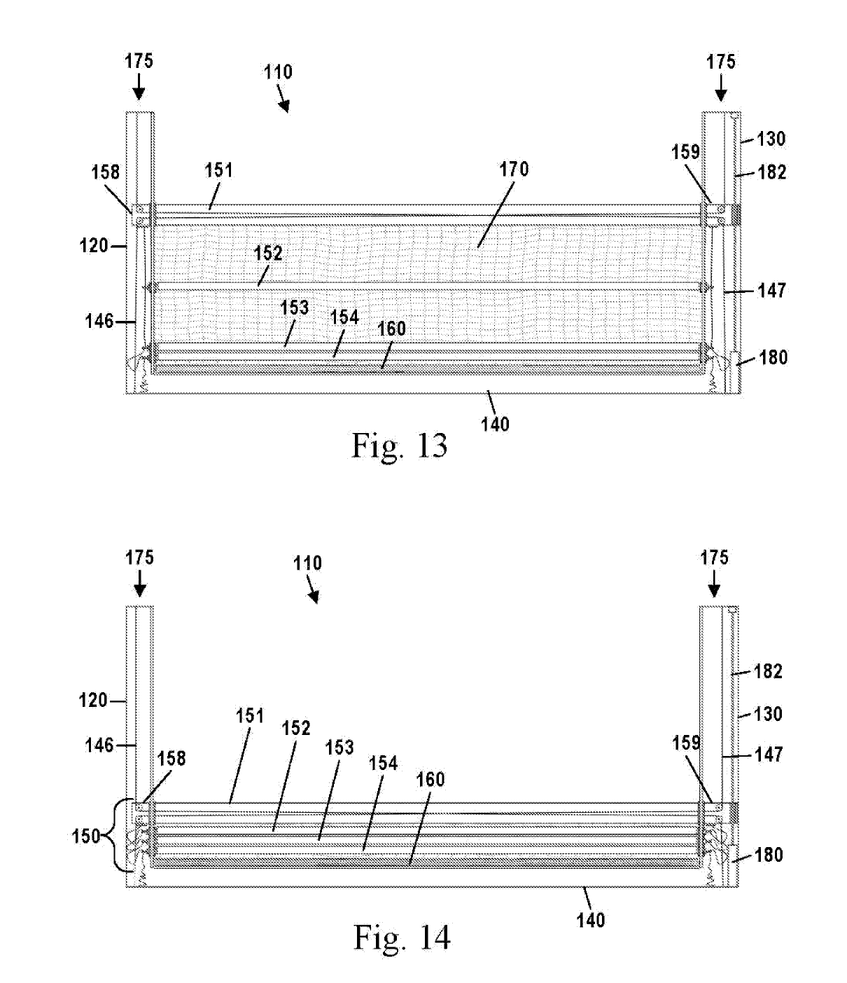

The flexible barrier 170 is suspended from the superior guard bar 151 and extends downwardly along an interior, support-surface-facing side of the side guard 150. It is made of a breathable material, such as a mesh fabric or fabric sheet, so that a patient whose face is resting against the barrier can still breathe. The roller 160, which is preferably mounted at the bottom of the side guard 150 but may alternatively be mounted on the superior guard bar 151 itself, holds the flexible barrier 170 in tension and winds up the flexible barrier 170 about itself as the superior guard bar 51 descends into the lowered position. FIGS. 13-14 illustrate the winding up of the flexible barrier 170 about the roller 160 as the side guard 150 descends from its most elevated position to its most lowered position.

FIGS. 16-19 illustrate another embodiment of a side guard apparatus 310 for a bed, with a hand-operated, manual balanced motion lift mechanism 375 for raising and lowering the guard bars 351 and 52-54. The side guard apparatus 310 of FIGS. 16-19 is similar to the side guard apparatus 10 of FIGS. 1-10. The side guard apparatus 310 comprises a side guard 350, a balanced motion lift mechanism 375 for raising and lowering the side guard 350 between elevated and lowered positions, a brake 380 for fixing the side guard 350 at a selected position, and a foot-end guide mechanism or post 30, a head-end guide mechanism or post 20, and a base bar 40 that houses the balanced motion lift mechanism 375 and provides structural rigidity to the side guard apparatus 310. The side guard apparatus 310 may be installed on a pre-existing bed (not shown), or alternatively the side guard 350 and balanced motion lift mechanism 375 may be installed within the existing structure of a bed, as shown in FIG. 21.

Like the side guard 50 of FIGS. 1-10, side guard 350 comprises a superior guard bar 351 that supports (and, in some embodiments, defines) a top horizontal edge of the side guard 350, a plurality of movable guard bars 52-54 suspended below the superior guard bar 351 by flexible elongated connectors 57 (e.g., lift cords, lift ropes, or lift straps), a substantially continuous flexible barrier 70 positioned on a support-surface-facing-side of a bed (not shown), and a torsion spring roller 60 that rolls up (or unwinds) the flexible barrier 70 as the guard bars 51-54 descend (or ascend). The guard bars 351 and 52-54 are free to move only within a vertical plane, and only up and down (with substantially no rotation). The terminal ends of guard bars 351 and 52-54 are slidably mounted on guide rods 93 between the rails 91, 92 (FIG. 20) of vertical guides or tracks 90 positioned on or near the inside surfaces of the guide posts 20 and 30, thereby allowing vertical movement while substantially preventing rotational or horizontal movement of the guard bars 351 and 52-54.

The balanced motion lift mechanism 375 comprises a closed drive loop 345 (e.g., a steel cable, a cord, a chain, a belt, etc.) mounted (as with FIGS. 1-10) on a plurality of pivots 25-27 and 35-37 and a compression spring 320 that counteracts the forces of gravity acting on the side guard 350. The balanced motion lift mechanism 375 of FIGS. 16-19, unlike the lift mechanism 75 of FIGS. 1-10, does not include a powered linear actuator 80. Rather, the superior guard bar 351 is raised and lowered by hand. Because the superior guard bar 351 is coupled to a fixed point on the closed drive loop 345 (i.e., the point is fixed with respect to and moves with the closed drive loop 345), movement of the superior guard 351 simultaneously causes movement of the closed loop drive 345. Furthermore, movement of the closed drive loop 345 balances the forces on both ends of the superior guard bar 351, in the same manner that the closed drive loop 345 does for superior guard bar 51 in FIGS. 1-10. Thus, if manual force is placed on the foot end of the superior guard bar 351, the closed drive loop 345 transfers some of that force to the head end of the superior guard bar 351, facilitating smooth motion of the superior guard bar 351 through the limits of its range of travel.

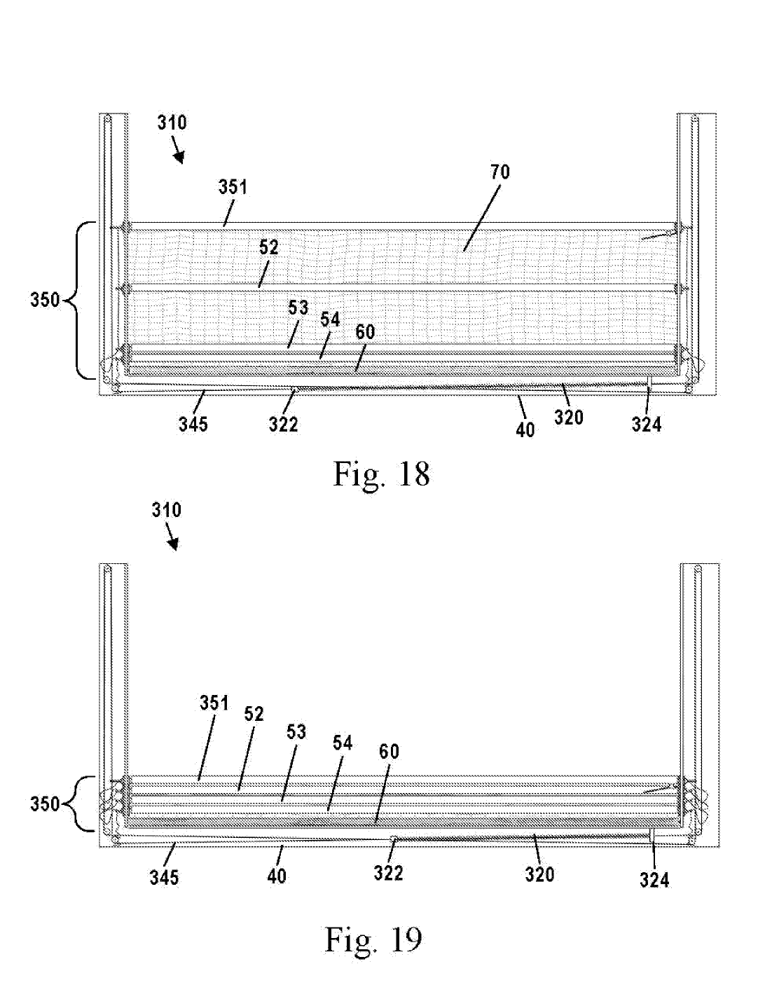

The compression spring 320 biases the side guard 350 upward, significantly reducing the effort needed to raise or lower the side guard 350. One end of the compression spring 320 is connected to the closed drive loop 345 at a fixed point by repositionable coupling 322 (i.e., the coupling 322 is fixed with respect to and moves with the closed drive loop 345). The opposite end of the compression spring 320 is rigidly attached to the base bar 40 or bed frame (not shown). The compression spring 320 is also coiled around the closed drive loop 345. As the side guard 350 is lowered, the compression spring 320 is compressed, as illustrated in FIGS. 18 & 19. Preferably, the position along the closed drive loop 345 of the repositionable coupling 322 of the compression spring 320 is calibrated so that no effort is needed to pull the superior guard bar 351 up to its fully elevated position. Rather, a slight amount of effort is needed to push the superior guard bar 351 down to its fully lowered position.

FIG. 17 illustrates one embodiment of a brake 380 for fixing the side guard 350 at a selected position. The brake 380 is affixed to the foot end 359 of the superior guard bar 351. The brake 380 comprises a brake handle 383 that is pivotally mounted to the superior guard bar 351 by a fulcrum 381 about which the brake handle 383 articulates. A braking member 384 opposite the brake handle 383 frictionally engages the guide rod 93 when the brake handle 383 is in the engaging position. A spring 382 biases the brake handle 383 into an engaged position. To disengage the brake 380, a person lifts the brake handle 383, which causes the braking member 384 to pivot into a position that does not engage the guide rod 93, allowing the superior guard bar 351 to slide freely up and/or down the guide rod 93.

FIG. 21 illustrates an embodiment of a mechanical bed of a type described and depicted in application Ser. No. 11/869,696 entitled “Bed with Adjustable Patient Support Framework” filed on Oct. 9, 2007, which application is herein incorporated by reference. In particular, an adjustable bed 210 is depicted having a patient support surface 220; a patient support structure 230 for supporting the patient support surface 220; and right and left side guard apparatuses 240 and 250, of a type described previously in this application, installed on either side of the patient support surface 220. The right side guard apparatus 240 is depicted in a fully elevated position, while the left side guard apparatus is depicted in a fully lowered position, below the support surface 220 of the bed 210.

The left side guard apparatus 250 is mounted between a head end guide mechanism 251 and a foot end guide mechanism 252. The head end guide mechanism 251 is integral with the head-end frame subsection 260 of the bed 210. The foot end guide mechanism 252 is integral with the foot-end frame subsection 270 of the bed 210. The right side guard apparatus 240 is similarly mounted between a head end guide mechanism (concealed) and a foot end guide mechanism (concealed) that are integral with the head-end frame subsection (or headboard) 260 and foot-end frame subsection (or footboard) 270, respectively. For embodiments in which the side guard apparatuses are powered, a user interface 290 (such as a computer-operated touch-screen, keyboard, trackball, mouse, switch, or button) is provided to activate the motor or actuator (not shown) driving the side guards 240 and 250 between their elevated and lowered positions.

The patient support structure 230 comprises a plurality of adjacent lateral patient support sections 231-234, including a first support section 231 adjacent to second support section 232. The first support section 231 is adapted to articulate about a transversal axis of rotation (not shown) between a substantially level position and an inclined position. It should be understood that the invention, unless and to the extent explicitly so limited by the claims, is not limited to hospital beds, much less of the type shown in FIG. 21, and can be incorporated in a large variety of hospital and non-hospital beds.

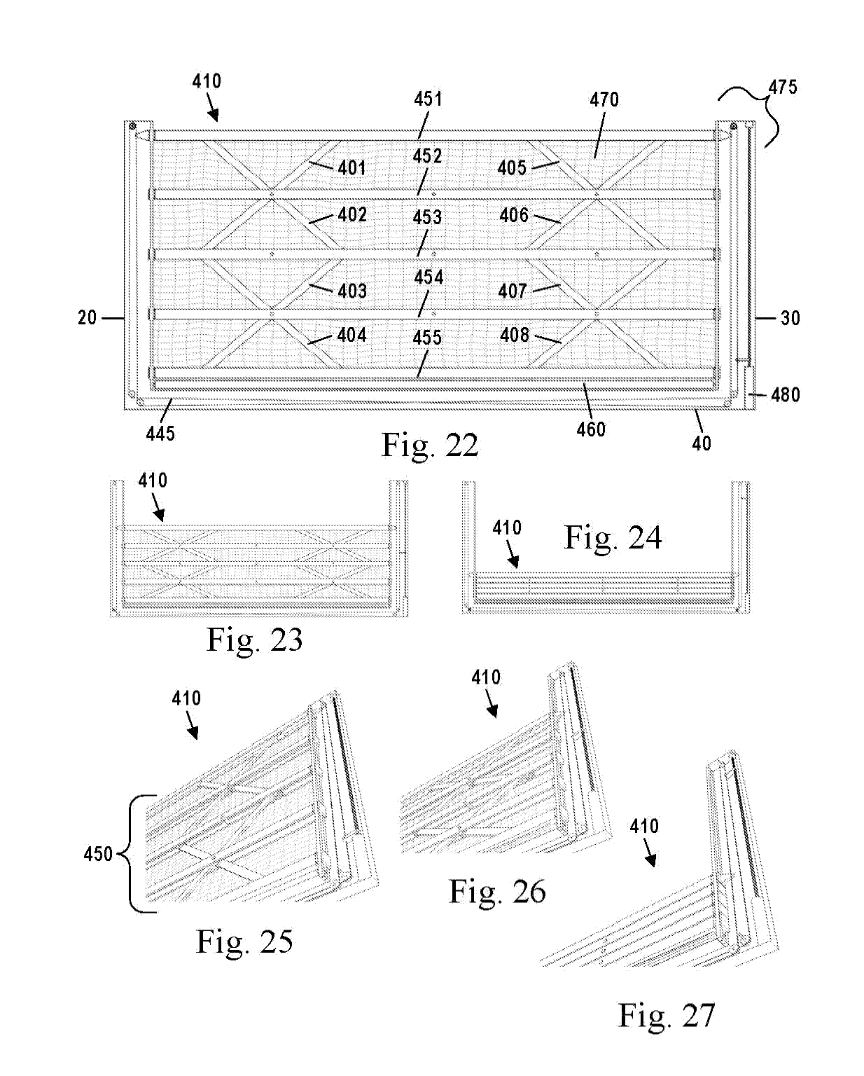

FIGS. 22-27 illustrate another alternative embodiment of a side guard apparatus 410. Side guard apparatus 410 comprises a side guard 450 and a pulley-based balanced motion lift mechanism 475 like that of FIGS. 1-10 for raising and lowering the side guard 50 between elevated and lowered positions. Side guard apparatus 410 further comprises a foot-end guide mechanism or post 30, a head-end guide mechanism or post 20, and a base bar 40 that houses the lift mechanism 475 and provides structural rigidity to the side guard apparatus 410. The side guard apparatus 410 may be installed on a pre-existing bed (not shown), or alternatively the side guard 450 and lift mechanism 475 may be installed within the existing structure of a bed, as shown in FIG. 21.

The side guard 450 comprises a superior guard bar 451 that supports (and, in some embodiments, defines) a top horizontal edge of the side guard 450, a plurality of movable guard bars 452-455 positioned below, and linked to, the superior guard bar 451 by angled segments 401-408, a substantially continuous flexible barrier 470 positioned on a support-surface-facing-side of a bed (not shown), and a roller 460 that rolls up (or unwinds) the flexible barrier 470 as the guard bars 451-454 descend (or ascend). The guard bars 451-454 are free to move only within a vertical plane, and only up and down. The terminal ends of guard bars 451-454 are slidably mounted between the rails 91, 92 (FIG. 20) of vertical guides or tracks 190 (FIG. 15) positioned on or near the inside surfaces of the guide posts 20 and 30, thereby restraining the movement of the guard bars 451-454 within that vertical plane.

Unlike the side guard 50 of FIGS. 1-10, side guard 450 has angled segments 401-408, pairs of which are arranged in scissors-like configurations, that link guard bars 451-454. In FIG. 22, two angled segments 402 and 405 extend down and to the right from sliding mounts on superior guard bar 451 to sliding mounts on inferior guard bar 453. Two more angled segments 401 and 406 extend down and to the left from sliding mounts on superior guard bar 451 to sliding mounts on inferior guard bar 453. Angled segments 401 and 402 form a scissors-like pair that intersects at, and is pivotally (but not slidably) joined to, inferior guard bar 452. Likewise, angled segments 405 and 406 form a scissors-like pair that intersects at, and is pivotally (but not slidably) joined to, inferior guard bar 452. Another scissors-like pair of angled segments 403 and 404, positioned directly below the pair of segments 401 and 402, join inferior bars 453 and 454 to base bar 455. Yet another scissors-like pair of angled segments 407 and 408, similar to and positioned directly below the pair of segments 405 and 406, also join inferior bars 453 and 454 to base bar 455.

Because the bars 451-455 are all linked by the scissors-like configurations of angled segments 401-408, the side guard apparatus 410 of FIGS. 22-27 does not include the elongated flexible connectors (e.g. lift cords) 57 of FIGS. 1-10. Furthermore, the scissors-like configurations of angled segments 401-408 maintain a proportional spacing between bars 451-455 as the side guard 450 is raised and lowered, as illustrated in FIGS. 23-27. This configuration advantageously provides more uniform support to the flexible barrier 470. The scissors-like configurations of the angled segments 401-408 also further helps distribute the forces raising and lifting guard bars 451-454, and in that sense can be considered a contributing part of the lift mechanism 475.

The flexible barrier 470 also protects the patient from becoming entrapped between the segments 401-408 as the side guard 450 is lowered. The scissors-like configuration of FIGS. 22-28, however, may be less aesthetically pleasing and partially obstruct the view of the patient, so for some the scissors-free embodiments of FIGS. 1-19 may be preferable. To mitigate these disadvantages, it is preferred that segments 401-408, and perhaps also the guard bars 451-454 themselves, be constructed of a transparent or translucent material.

Another further embodiment, not shown because it can be described adequately in reference to FIGS. 22-27, is like FIGS. 22-27 but replaces the closed drive loop 445 in the lift mechanism 475 of FIGS. 22-27 with a dual-cord lift mechanism as described in connection with FIGS. 12-15. Yet another further embodiment, not shown because it can be described adequately in reference to FIGS. 22-27, is like FIGS. 22-27 but replaces the linear actuator 480 in the lift mechanism 475 of FIGS. 22-27 with the manual, spring-tensioned lift mechanism of FIGS. 16-19.

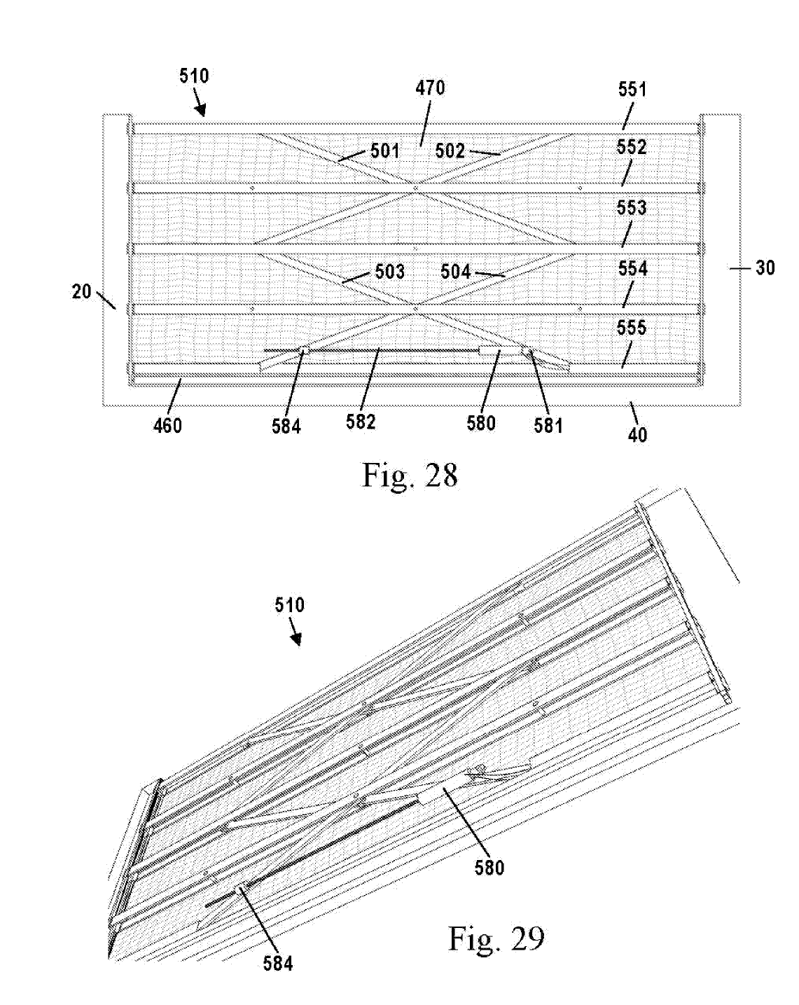

FIGS. 28-29 illustrate yet another alternative embodiment of side guard apparatus 510. As is apparent from the drawings, side guard apparatus 510 is like side guard apparatus 410 of FIGS. 22-27 in many ways. But side guard apparatus 510 replaces the four pairs of scissors-like segments 401-408 with just two pairs of scissors-like segments 501-504. Furthermore, side guard apparatus 510 does not incorporate the pulley-based balanced motion lift mechanism 475 of FIGS. 22-27. Instead, side guard apparatus 510 includes a horizontally-oriented, screw-type linear actuator 580 that drives segments 503 and 504 together, or apart, in order to raise or lower the side bars 551-554.

The linear actuator 580, together with scissors-like segments 501-504, form a balanced-movement lift mechanism for the side guard apparatus 510. The base 581 of linear actuator 580 is pivotally mounted to segment 503. A nut 584, through which the threaded shaft 582 of linear actuator 580 rotates, is pivotally mounted on segment 504. Actuation of the linear actuator 580 causes the shaft 582 to turn, pushing or pulling the nut 584 away from the actuator base 581. Screw-type linear actuator 580 may optionally be replaced with a rod type linear actuator having a telescoping (rather than rotating) shaft.

Yet another further embodiment, not shown because they can be described adequately in reference to FIGS. 28-29, is like FIGS. 28-29 but eliminates inferior guard bars 552 and 554. Yet another embodiment, also not shown because it can be described adequately in reference to FIGS. 28-29, is like FIGS. 28-29 but replaces the two pairs of scissors-like segments 501-504 with a single pair of scissors-like segments extending from superior guard bar 551 to base bar 555, and eliminates inferior guard bars 552-554.

This specification also incorporates herein by reference, the following patent applications: application Ser. No. 12/120,363 entitled “Adjustable Bed With Sliding Subframe for Torso Section” filed on May 14, 2008; Application No. 60/979,836 entitled “Patient Support Surface with Modulating Hip-Cradling Perimeter” filed on Oct. 14, 2007; App. No. 60/979,837 entitled “Adjustable Bed with Sacral Pressure Relieve Function” filed on Oct. 14, 2007; and App. No. 60/979,838 entitled “Modulating Support Surface to Aid Patient Entry and Exit” filed on Oct. 14, 2007.

This specification also incorporates by reference the following disclosures filed as part of the Patent and Trademark Office's Document Disclosure Program: the disclosure by Eduardo R. Benzo and Rodolfo W. Ferraresi entitled Levita-Bed System, received by the Patent and Trademark Office on Dec. 27, 2005, and assigned document number 592241; the disclosure by Eduardo R. Benzo, Rodolfo W. Ferraresi, and Mario C. Eleonori entitled Dynamic Multipositional Hospital Bed, received by the Patent and Trademark Office on Feb. 27, 2006, and assigned document number 596795; the disclosure by Eduardo R. Benzo, Rodolfo W. Ferraresi, and Mario C. Eleonori entitled Dynamic Multipositional Hospital Bed, received by the Patent and Trademark Office on Jul. 19, 2006, and assigned document number 603707; the disclosure by Eduardo R. Benzo, Rodolfo W. Ferraresi, and Mario C. Eleonori entitled Use and Control Methods for Multipositional Beds, received by the Patent and Trademark Office on Dec. 13, 2006, and assigned document number 610034; and the disclosure by Eduardo R. Benzo, Rodolfo W. Ferraresi, and Mario C. Eleonori entitled System for Virtual Communication between Patient and the Rest, received by the Patent and Trademark Office on Dec. 23, 2006, and assigned document number 610042.

To the extent that the claims refer to a superior guard bar 51 that “supports” a top horizontal edge of a side guard 50, this is intended to encompass embodiments where the superior guard bar 51 defines the top horizontal edge of the side guard 50 as well as embodiments where the superior guard bar 51 supports some additional structure (e.g., the top of the flexible barrier 70, padding, or other decorative or structural enhancements) that defines the top horizontal edge of the side guard 50.

Having thus described exemplary embodiments of the present invention, it should be noted that the disclosures contained in FIGS. 1-21 are exemplary only, and that various other alternatives, adaptations, and modifications may be made within the scope of the present invention. Accordingly, the present invention is not limited to the specific embodiments illustrated herein, but is limited only by the following claims.

1. A hospital bed comprising:
a patient support surface;
a patient support structure for supporting the patient support surface;
the patient support structure comprising a plurality of adjacent lateral patient support sections, including a first support section adjacent to second support section;
the first support section being adapted to articulate about a lateral axis of rotation between a substantially level position and an inclined position; and
a side guard comprising:
a superior guard bar extending along substantially all of a side of the patient support surface supporting a top horizontal edge of the side guard;
a plurality of inferior guard bars parallel to the superior guard bar and positioned below the superior guard bar; and
a lift mechanism for uniformly raising and lowering the superior guard bar within a vertical plane between lowered and elevated positions without rotating the superior guard bar.

2. The hospital bed of claim 1, wherein the side guard further comprises a substantially continuous flexible barrier suspended from the superior guard bar and extending downwardly along an interior, support-surface-facing side of the side guard.

3. The hospital bed of claim 2, wherein the substantially continuous flexible barrier comprises a fabric sheet.

4. The hospital bed of claim 2, further comprising a roller mounted on the side guard operable to hold the flexible barrier in tension and to roll up the flexible barrier as the superior guard bar descends into the lowered position.

5. The hospital bed of claim 4, further comprising a torsion spring positioned inside the roller, the torsion spring providing the tension on the flexible barrier and causing the roller to roll up the flexible barrier as the superior guard bar descends into the lowered position.

6. The hospital bed of claim 5, wherein the roller is positioned near a bottom end of the side guard.

7. The hospital bed of claim 1, wherein the inferior guard bars are suspended below the superior guard bar by flexible elongated connectors that are separate and distinct from the substantially continuous flexible barrier that is suspended from the superior guard bar and extends downwardly along an interior, support-surface-facing side of the side guard, wherein the flexible elongated connectors position the guard bars in spaced-apart relation when the superior guard bar is in its elevated position, and allow the bars to collapse upon each other when the superior guard bar is in its lowered position.

8. The hospital bed of claim 1, wherein the lift mechanism is a pulley-balanced lift mechanism.

9. The hospital bed of claim 1, further comprising:
a head end guide mechanism for guiding a head end of the superior guard bar;
a foot end guide mechanism for guiding a foot end of the superior guard bar; and
wherein the superior guard bar has terminal ends mounted for sliding within the parallel vertical guides, and wherein the inferior guard bars also have terminal ends mounted for sliding within the parallel vertical guides to restrain movement of the inferior guard bars within a vertical plane, wherein the lift mechanism is operable to synchronously raise and lower the head and foot ends of the superior guard bar.

10. The hospital bed of claim 1, wherein the lift mechanism comprises:
a head end guide mechanism for guiding a head end of the superior guard bar;
a foot end guide mechanism for guiding a foot end of the superior guard bar;
a first set of one or more pivots mounted on said head end of the superior guard bar;
a second set of one or more pivots mounted on said foot end of the superior guard bar;
a first tensioned line that extends from a lower portion of the head end guide mechanism, over one of the first set of pivots, across the superior guard bar, under one of the second set of pivots, and terminating near a top end of the foot end guide mechanism; and
a second tensioned line that extends from a lower portion of the foot end guide mechanism, over one of the second set of pivots, across the superior guard bar, under one of the second set of pivots, and terminating near a top end of the head end guide mechanism;
wherein the lift mechanism is operable to synchronously raise and lower the head and foot ends of the superior guard bar.

11. The hospital bed of claim 1, wherein the lift mechanism comprises:
a head end guide mechanism for guiding a head end of the superior guard bar;
a foot end guide mechanism for guiding a foot end of the superior guard bar; and
a closed drive loop mounted on a plurality of pivots, the closed drive loop being coupled to the head and foot ends of the superior guard bar, whereby the closed drive loop is operable to synchronously raise and lower the head and foot ends of the superior guard bar.

12. A bed comprising:
a support surface;
a side guard comprising:
a superior guard bar supporting a top horizontal edge of the side guard;
a lift mechanism operable to raise and lower the superior guard bar within a vertical plane between lowered and elevated positions without rotating the superior guard bar; and
a substantially continuous flexible barrier suspended from the superior guard bar and extending downwardly along an interior, support-surface-facing side of the side guard.

13. The bed of claim 12, further comprising a roller mounted on the side guard operable to hold the flexible barrier in tension and to roll up the flexible barrier as the superior guard bar descends into the lowered position.

14. The bed of claim 13, further comprising:
a head end guide mechanism for guiding a head end of the superior guard bar;
a foot end guide mechanism for guiding a foot end of the superior guard bar; and
wherein the lift mechanism is operable to synchronously raise and lower the head and foot ends of the superior guard bar.

15. The bed of claim 14, wherein the lift mechanism comprises:
a first pair of pivots mounted on said head end of the superior guard bar;
a second pair of pivots mounted on said foot end of the superior guard bar; and
a first tensioned line that extends from a lower portion of the head end guide mechanism, over one of the first pair of pivots, across the superior guard bar, under one of the second pair of pivots, and terminating near a top end of the foot end guide mechanism; and
a second tensioned line that extends from a lower portion of the foot end guide mechanism, over one of the second pair of pivots, across the superior guard bar, under one of the second pair of pivots, and terminating near a top end of the head end guide mechanism.

16. A bed comprising:
a support surface;
a side guard comprising:
a superior guard bar supporting a top horizontal edge of the side guard;
a head end guide mechanism for guiding a head end of the superior guard bar;
a foot end guide mechanism for guiding a foot end of the superior guard bar; and
a drive mechanism, driven by a single linear actuator, operable to synchronously raise and lower the head and foot ends of the superior guard bar within a vertical plane between lowered and elevated positions without rotating the superior guard bar.

17. The bed of claim 16, wherein the drive mechanism comprises a closed drive loop, wherein the closed drive loop extends from the head end guide mechanism to the foot end guide mechanism and is driven by the single linear actuator.

18. The bed of claim 17, wherein the closed drive loop is coupled to the superior guard bar at two points, whereby the closed drive loop is operable to synchronously raise and lower the head and foot ends of the superior guard bar.

19. The bed of claim 18, wherein the closed drive loop is a cable mounted on a plurality of pivots.

20. The bed of claim 18, further comprising a breathable and substantially continuous flexible barrier suspended from the superior guard bar and extending downwardly along an interior, support-surface-facing side of the side guard, wherein the breathability of the flexible barrier enables a patient to breathe even if the patient's face is resting against the barrier.
